(19) United States
(12) Patent Application Publication
(10) Pub. No.: US 2012/0017844 A1
(43) Pub. Date: Jan. 26, 2012

(54) LOOSE LEASH ANIMAL TRAINING APPARATUS

(76) Inventor: Calvin G. Nelson, Shorewood, MN (US)

(21) Appl. No.: 13/185,137

(22) Filed: Jul. 18, 2011

Related U.S. Application Data
(60) Provisional application No. 61/366,234, filed on Jul. 21, 2010.

(51) Int. Cl. A01K 15/04; A01K 29/00

(52) U.S. Cl. 119/712

(57) ABSTRACT

A canine training device configured to work in conjunction with the leash of a dog to transmit a non-invasive stimulus to a dog based on the relative positioning of the dog leash connected to the dog or dog collar. The canine training device includes a position sensor in the form of a tilt switch that is either attached to or built into the dog leash. Movement of the dog in any direction beyond that permitted by its handler causes a change in relative position of the leash, thereby closing the tilt switch and activating a vibratory stimulus generator that transmits vibration to the dog, thus alerting the dog to correct its course well prior to creating any significant tension on the leash.

### CROSS REFERENCE TO RELATED APPLICATIONS

This application is an application for a patent which is also disclosed in Provisional Application Ser. No. 61/366,234, filed on Jul. 21, 2010 by the same inventor, namely Calvin G. Nelson, and entitled “LOOSE LEASH ANIMAL TRAINING APPARATUS,” the benefit of the filing date of which is hereby claimed.

### BACKGROUND OF THE INVENTION

The present invention relates generally to the art of training devices for animals. More particularly, the present invention relates to devices utilized for leash training of pet animals and obedience pre-training of such animals prior to using so-called “e-collars” (i.e., electronic shock collars). Although the present invention has application to the training of most any domestic animal, it is particularly relevant to canines (dogs); therefore, for illustrative purposes only, the following discussion will focus primarily on leash training of dogs.

The proper and/or best method for training one's household animals, particularly dogs, has long since been a subject of considerable and passionate debate. It is fairly well settled, however, that using proactive “positive” training techniques is useful in developing a stronger communication and trusting relationship between the dog and its handler. Loose leash training is one such technique, where the goal is to teach the dog to walk or run beside a human without jerking or pulling on the leash. Although there are many schools of thought on this subject, in general, veterinarians and trainers alike strongly recommend loose leash training. Loose leash training reduces the potential for injuries to the dog as well as the dog handler, and makes a much more enjoyable interaction and less emotional stress for both.

Various devices have heretofore been employed that work in conjunction with a leash to provide some form of stimulus to the dog when too much tension is exerted on the leash. One such device, known as the “choke collar,” is designed to alert the dog by choking its air passageway. Another device, known as the “prong collar” utilizes a plurality of prongs or teeth to engage the dog's neck when tension is placed on the leash. Neither the “choke” or “prong” collar subscribes to the “loose leash” theory in that the harder the dog pulls, the more physically invasive the collar becomes, thus making it more unpleasant for the dog.

Other shock collar (e-collar) devices, such as that shown in U.S. Pat. No. 6,003,474, are also available. These devices typically employ the combination of a leash tension-sensing apparatus and an electric stimulus circuit that delivers a shock to the dog upon exceeding a predetermined tension threshold in the leash. Such devices are highly controversial due to the generally strong disfavor of the general public toward shocking animals to gain obedience. Moreover, such devices provide the shock stimulus only after tension beyond a certain threshold is reached, thus reacting (as opposed to being proactive) to the problem with a negative or punishing stimulus (e.g., shock). This oftentimes can result in the dog becoming frightened and confused, leading to possible overexcitement and consequent additional shocking.

The controversy over the use of such shock collars in the pet industry has resulted in a recent shift in industry advertising to replace the term “shock collar” with the term “e-collar.” Some countries, such as Wales, Australia, Germany, Switzerland, Sweden, Denmark, Austria and Slovenia have already banned the use of shock collars; it is expected that other countries will soon follow. Other organizations have also been active in opposing the use of shock collars and are fighting to outlaw them, e.g., the Royal Society for the Prevention of Cruelty to Animals; PETA; Best Friends Animal Society; The Humane Society of the United States; No Shock Collar Coalition; and the Association of Pet Dog Trainers (UK).

Other less invasive leash training devices are available, however, such as that shown and described in U.S. Pat. No. 5,494,002. With this device, a mechanical trigger is responsive to a force exerted thereon by the leash so that tensioning the leash activates a sound generator, which alerts the dog to stop pulling. While effective, trigger activation only occurs after the fact, once tensioning of the leash has occurred. Moreover, the trigger is mechanical by nature and the activation force may vary depending on weather conditions and/or general wear and tear of the trigger.

Still another leash training device is disclosed in U.S. Pat. No. 6,612,264, wherein a mechanical sound-generating apparatus responsive to leash tension is provided. Here again, however, the dog is not alerted until after a fairly significant force is applied to the leash, and the mechanical sound generator (comprising inter-engaging threaded members) is susceptible to substantial and costly wear and tear through repeated use. Dog training head collars that loop over the dog's nose are also available, but these devices are annoying to the dog. While effective in causing the dog to pull less on the leash, fairly significant tensioning of the leash must occur before the dog realizes that it is engaging in undesirable behavior.

Common to all the aforementioned leash training devices is the need for fairly significant tensioning of the leash before the dog is alerted to stop. In most cases, the dog receives no alerting stimulus until after it has tugged on the leash with enough force to activate the stimulus mechanism associated therewith. Whether this is a tightening or pulling on the dog's snout, an electric shock, or some other stimulus (such as an audible sound), the stimulus is generated too late and the dog learns that at least some tension on the leash is permissible.

Since it is the goal of loose leash training to teach the pet to walk beside its handler without any jerking or pulling on the leash, it is evident that it would be advantageous to provide a means by which the dog is alerted before any significant tension is created on the leash. Such early detection and alert transmitted to the dog may also be advantageous in signaling the dog handler to stop at the appropriate time to permit the dog to heel to the handler's side. In this manner, the dog is also indirectly trained to heel by training the dog handler when to stop. In keeping with these goals, it would therefore also be advantageous to provide a cost-effective training device with adequate sensitivity to at least alert the dog (and preferably the handler) when the dog has begun to deviate from its desired position/course relative to its handler, yet before any significant tension is permitted to have occurred on the leash itself.

### BRIEF SUMMARY OF THE INVENTION

In keeping with the above asserted goals for loose leash training, one principal object of the present invention is therefore to overcome the deficiencies of the above-described leash training devices by providing an improved cost-effective leash training device with sufficient sensitivity to alert a dog well before any significant tensioning occurs on the leash.

Another object of the present invention is to provide an improved leash training device that can be produced at a low cost and will alert a dog on a leash to react in a desired manner based more on the relative positioning of the dog to its handler than on the tension placed on the dog leash.

It is still a further object of the present invention to provide an improved low-cost leash training device that works in conjunction with a leash to alert a dog with non-invasive stimulus based on the dog's positioning relative to its handler, to cause the dog to react as desired without exerting significant tension on the leash.

The foregoing objects and others are achieved through use of the present invention. In accordance therewith, a canine training device is configured to work in conjunction with the leash of a dog to transmit a preferably non-invasive stimulus (i.e., via sound, vibration, buzzing, sight, scent, etc., or a combination thereof) to the dog based on the relative positioning or angle of the dog leash connected to the dog or its collar. In this embodiment, it is contemplated that the canine training device be comprised of a position sensing switch that is either attached to or built into the dog leash. Movement of the dog in any direction beyond that permitted by its handler will cause a change in relative position of the leash, thereby closing the position sensing switch. Closure of the position sensing switch in turn activates a stimulus generator within the training device that transmits the desired stimulus to the dog, thus alerting the dog to correct its course well prior to creating any significant tension on the leash. Depending on the type of stimulus generated, the handler of the dog should also be alerted of the dog's breach in positioning prior to creating any significant tension on the leash.

Alternatively, it is contemplated that the position sensing switch could also be secured (e.g., clipped or otherwise attached in some manner) between the leash and collar, or connected directly to the collar, without departing from the invention herein. In either embodiment, as the dog moves beyond the permitted zone of travel, the position sensing switch in the training device will be caused to activate, thereby triggering the stimulus generator and alerting the dog to right its course prior to experiencing any significant tension on the leash.

In one embodiment, it is preferred that the stimulus generator be movably mounted within an electrically conductive housing, such that any movement of the dog beyond the permitted zone of travel will cause the stimulus generator itself to shift from a deactivated non-conductive position to an activated conductive position within the housing. In this embodiment, gravity maintains constant electrical contact between the stimulus generator and the outer conductive housing. Consequently, any tilting of the training device beyond that permitted will cause the stimulus generator to shift positions to an orientation of conductivity within the housing, thereby closing the electrical circuit and energizing the stimulus generator to alert the dog that it has breached the permitted zone of travel. In this embodiment, the stimulus generator essentially serves the dual function of sensing the dog's position and providing an alerting stimulus thereto.

In another embodiment, it is contemplated that the position switch within the canine training device be composed of a separate electronic tilt switch that is either attached to or built into the dog leash. In this embodiment, movement of the dog in any direction beyond that permitted by its handler will cause a change in leash angle, thereby tilting the switch enough (approximately above horizontal) to close the electrical contacts within the switch. Once switch contact is made, the stimulus generator within the training device is activated, which generates and transmits the desired stimulus to the dog, thus alerting the dog to correct its course well prior to creating any significant tension on the leash.

The simplicity of the above leash training device lends it to very low cost manufacturing and much higher reliability and uniformity of performance compared to the aforementioned leash training devices that rely principally on sensing leash tension. There are no mechanical sound generating mechanisms that are subject to wear and costly replacement, and no unreliable triggering caused by mechanical switch failure due to weather conditions, aging, etc.

It is contemplated that the stimulus generated by the training device may be of any form to alert the dog, but is preferably of a non-invasive nature. It is further contemplated that the training device could be configured to provide a single stimulus (e.g., vibration only), multiple stimuli such as tone and vibration combined, or the option to provide either. It is also contemplated that the position switch could be configured to remotely activate the stimulus generator, such as by way of radio signal.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a diagrammatic view of a dog on a leash that includes an animal training apparatus constructed in accordance with the present invention, showing the relative positioning of the training apparatus as intended to be used in conjunction with a leash for optimal performance;

FIG. 2 is a sectional view of an animal training apparatus constructed in accordance with the present invention, showing one embodiment of the stimulus circuitry utilized.

FIG. 3 is a sectional view of the animal training apparatus shown in FIG. 2, showing the end cap loosened to disengage the stimulus circuitry.

FIG. 4 is a sectional view of an alternative embodiment of the stimulus circuitry for use in connection with the animal training apparatus of FIG. 1.

### DETAILED DESCRIPTION OF THE INVENTION

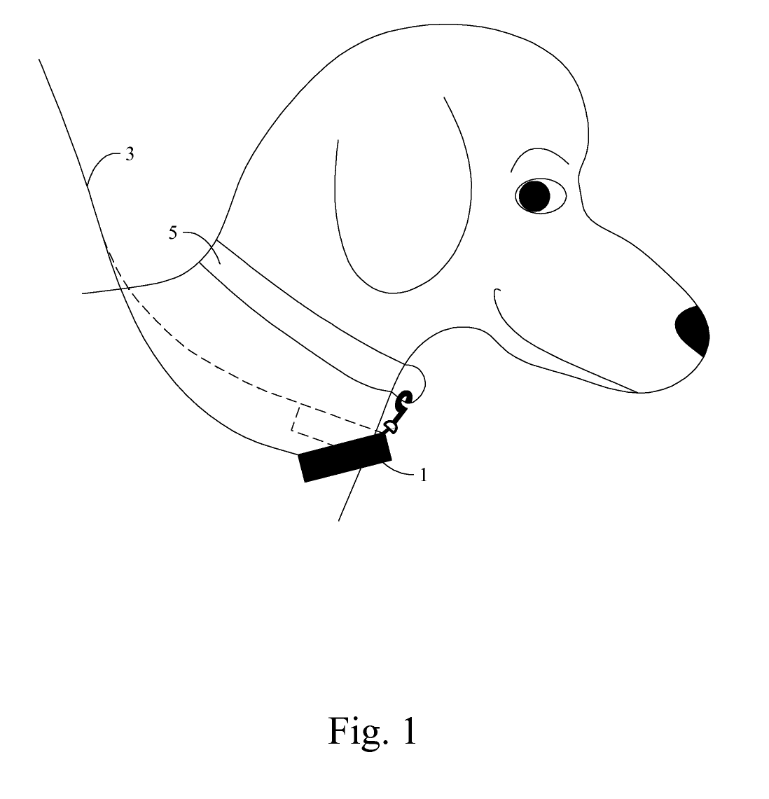

With reference to FIG. 1, an animal training apparatus 1, such as a canine training device, is shown constructed in accordance with the present invention. As shown, the canine training device 1 is designed to be used in conjunction with a leash 3, such as a dog leash, and may be integrally incorporated as a part of the leash 3 or collar 5, or connected thereto by any known means. In use, the training device 1 is designed in such manner as to function principally as a position sensor capable of sensing a positional change of the training device 1 relative to an established “home” position where the dog is expected to heel. Deviation from this position triggers an alert to the dog that it is not heeling well prior to creating any significant tension on the leash. It may also alert the handler that the dog has begun to stray, thereby teaching the handler when to stop for proper loose leash training.

By way of example, with reference to FIG. 1, it can be seen that movement of the dog has caused a deviation of the training device 1 from its desired “home” or “heeling” position (shown by solid lines) to a deviated position (shown in phantom), thereby causing the training device 1 to trigger an alert to the dog. In this manner, the canine training device 1 essentially monitors the position of the dog wearing the training device 1, and provides an alert to the dog when its position deviates from a predetermined desired or acceptable “heeling” position relative to its handler (not shown).

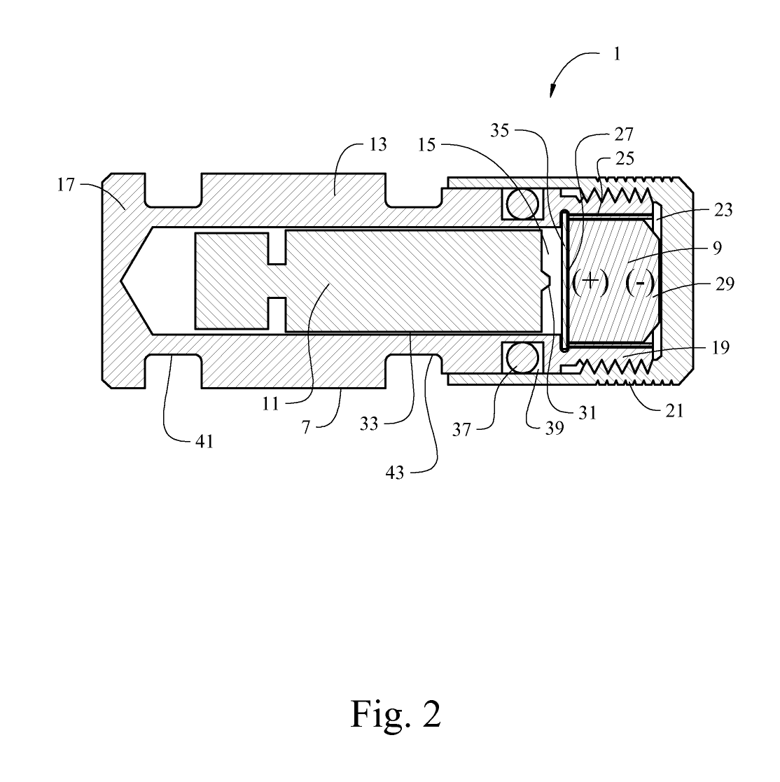

In one embodiment, the canine training device 1 is configured to work in conjunction with the leash 3 to transmit a preferably non-invasive stimulus (i.e., via sound, vibration, buzzing, sight, scent, etc., or combination thereof) to the dog based on the relative positioning or angle of the dog leash 3 connected to the dog, or its collar 5. As shown if FIG. 2, it is contemplated that the training device 1 be constructed generally of an electrically conductive outer housing 7 which carries therein an electrical power source or battery 9 and a movable electronic stimulus generating member 11. The housing 7 may be formed of any suitable electrically conductive material, including without limitation, aluminum, steel, brass, copper, or other conductive metals or composite materials. As shown, housing 7 is constructed with a main body tubular member or barrel 13 having a central bore or chamber 15 within which the stimulus generator 11 is carried in movable relation. The main body member 13 is closed at one end 17 and is threaded at the opposite end 19 to accommodate the housing end cap 21, which is also formed of an electrically conductive material. In FIG. 2, end 19 of the main body 13 is shown with male threads and cap 21 with mating female threads, but it will be appreciated that this could be readily reversed without departing from the invention herein.

In the present embodiment, activation of the stimulus generator 11 is effected by passing electrical current through its body. To this end, as shown in FIG. 2, the end cap 21 is formed with an interior cavity 23 designed to accommodate battery 9 of the electrical circuitry. Battery 9 is carried within a surrounding insulating sleeve 25, such that only the opposing positive and negative battery terminal ends 27 and 29, respectively, are exposed. As shown, the negative battery terminal 29 is constructed to contact the end cap 21 of housing 7 when threaded onto the main body 13 thereof, and is consequently electrically coupled thereto. The opposite positive terminal 27 of battery 9 is aligned with and faces the stimulus generator 11. The stimulus generator 11, in turn, has one electrical contact 31 facing battery 9, with its outer conductive body 33 constituting the other electrical contact.

As shown in FIG. 2, the stimulus generator 11 is constructed slightly smaller in diameter and shorter than chamber 15 of housing 7. This permits the stimulus generator 11 to slide freely back and forth within chamber 15, and depending on the position of the canine training device 1, contact 31 of the stimulus generator 11 will or will not engage the positive terminal 27 of the battery 9. Through gravity, the outer body 33 of the stimulus generator is in constant contact with housing 7 and is, therefore, electrically coupled to the negative terminal 29 of battery 9. Consequently, the positioning of the stimulus generator 11 within chamber 15 of housing 7 dictates whether the stimulus generator 11 is energized to produce an alerting stimulus to the dog. Any tilting of the training device 1 beyond that permitted will cause the stimulus generator 11 to shift positions from a non-conductive orientation within housing 7 to a conductive orientation, thereby closing the electrical circuit and energizing the stimulus generator 11 to alert the dog that it has breached the permitted zone of travel.

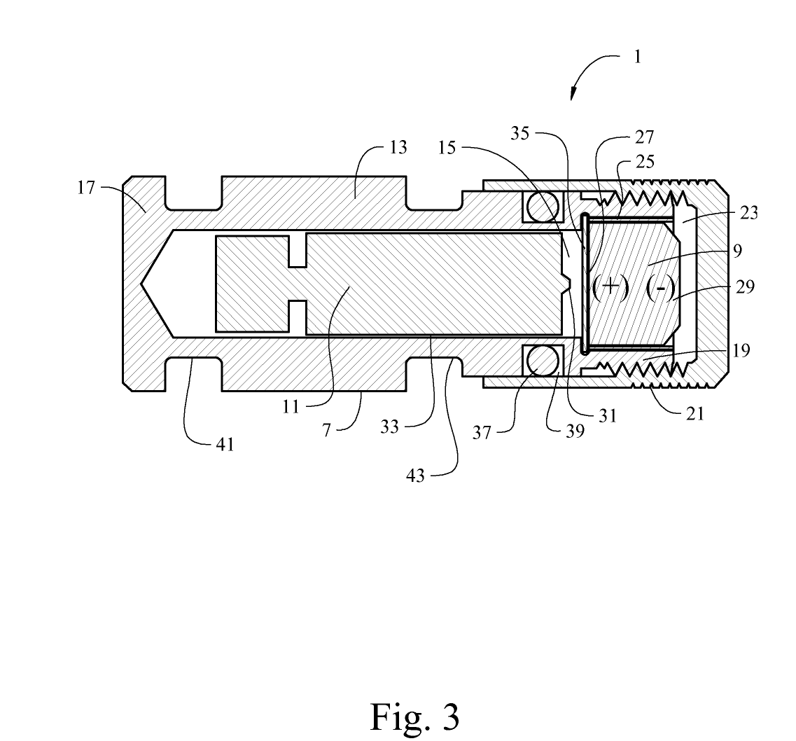

In FIG. 3, the end cap 21 is shown partially removed from the main body member 13 of housing 7. In this configuration, it can be seen that an insulating stop washer 35 is positioned directly between the battery 9 and stimulus generator 11. Stop washer 35 functions to prevent the stimulus generator 11 from pushing battery 9 against end cap 21, thus avoiding electrical engagement therewith unless and until end cap 21 is tightened down completely upon the main body member 13 of housing 7. With end cap 21 loosened, battery 9 is allowed to freely shift within cavity 23 without establishing electrical continuity between stimulus generator 11 and end cap 21. As shown in FIG. 2, however, upon tightening end cap 21, battery 9 is engaged and pushed tightly against stop washer 35, where the electrical contact 31 of the stimulus generator 11 engages the positive terminal 25 of battery 9 to complete electrical continuity. Consequently, the housing end cap 21 constitutes an ON/OFF switch for the canine training device 1, which is readily enabled or disabled by merely tightening or loosening end cap 21.

As seen further in FIGS. 2 and 3, a seal 37 is seated within a circumferential groove 39 formed in the main body 13 of housing 7 adjacent the threaded end 19 thereof. Seal 37 functions to effectively seal between the main body member 13 and end cap 21 of housing 7, thereby preventing moisture, dirt and other contaminants from entering the interior thereof where battery 9 and stimulus generator 11 are carried. As shown, housing 7 is also configured with a pair of additional exterior circumferential grooves 41 and 43, which are designed to accommodate a connecting or tying means for securing the canine training device 1 to the leash 3 or dog collar 5.

In use, the canine training device 1 may be attached to the leash 3, collar 5 or other clasp device (not shown) extending between the leash and collar, via any suitable connecting or tying mechanism. To enable the training device 1, the dog handler need only tighten the end cap 21 of housing 7, thereby causing battery 9 to press firmly against stop washer 35. Then, as the dog strays beyond its permissible zone of travel, before experiencing any tension on leash 3, the training device 1 will begin to tilt toward its orientation of conductivity, causing the stimulus generator 11 to slide toward the battery 9. The electrical contact 31 of the stimulus generator 11 will then engage the positive terminal 27 of battery 9 and close the electrical circuit therebetween. Upon contacting battery 9, the stimulus generator 11 is energized, thereby providing an alerting stimulus to the dog, and possibly the dog handler, that the dog has breached its permissible zone of travel. Once the dog heels, the position of the training device 1 will revert to its established “home” position and the stimulus generator 11 will shift away from battery 9, thereby deactivating the stimulus generator.

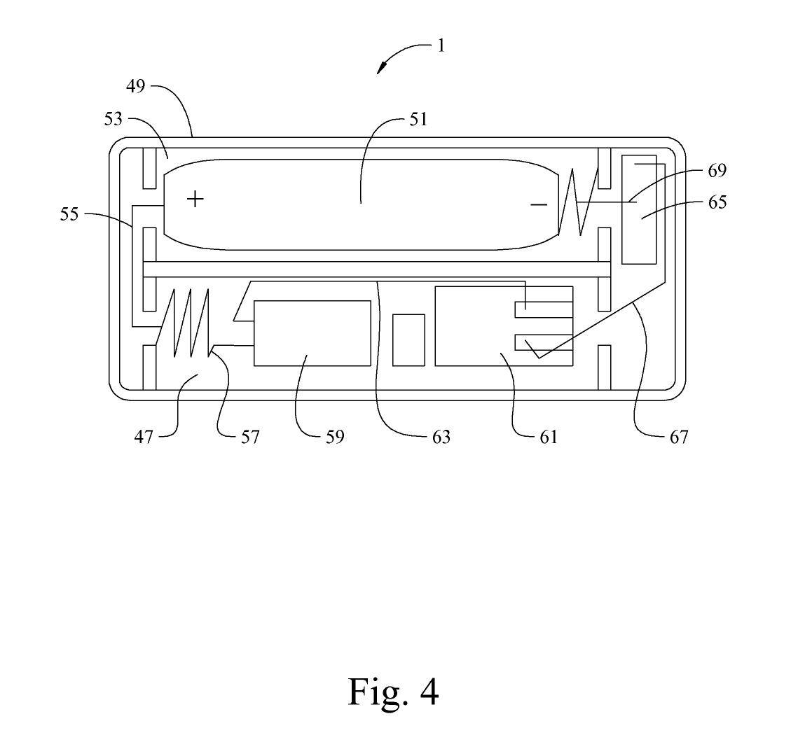

As shown in FIG. 4, in an alternate embodiment of training device 1, it is contemplated that the alerting stimulus to the dog be generated electronically via electronic stimulus circuitry 47 contained within an outer housing or casing 49 of the training device 1. In this embodiment, the outer casing 49 need not be formed of a conductive material. The stimulus circuitry 47 includes a battery 51 seated within the battery chamber 53 of case 49. An electrical contact 55 connects the positive terminal of battery 51 to a position sensing switch 59 through resistive element 57, thereby providing power to the stimulus circuitry 7. In turn, the position sensing switch 59 is electrically coupled to a stimulus generating member 61 via electrical wiring 63. To complete the stimulus circuit 47, a master ON/OFF switch 65 is electrically coupled between the negative terminal of battery 51 and the stimulus generating member 61 via electrical contact 67 and wiring 69. In this manner, the dog handler may activate the training device 1 as necessary or desired.

As with the previous embodiment, it is contemplated that the training device 1 with position sensing switch 59 may be either attached to or built into the dog leash 3, so as to be capable of sensing any change in the relative angle of the leash 3 as the dog moves. Movement of the dog in any direction beyond that permitted by its handler will then cause a change in relative position of the leash 3, thereby closing the position sensing switch 59. Closure of the position sensing switch 59 in turn activates the stimulus generator 61 within the training device 1, which then transmits the desired stimulus to the dog, thus alerting the dog to correct its course well prior to creating any significant tension on the leash 3.

It is further contemplated that the dog training device 1 with position sensing switch 59 could alternatively be secured (e.g., clipped or otherwise attached in some manner) between the leash 3 and collar 5, or incorporated into or connected in some manner directly to the collar 5. In either case, as the dog moves beyond the zone permitted by its handler, the position sensing switch 59 in the training device 1 will be caused to activate, thereby triggering the stimulus generator 61 and alerting the dog to right its course prior to experiencing any significant tension on the leash 3.

Notably, in the embodiment of FIG. 4, the position sensing switch 59 is separate from the stimulus generator 61, which facilitates adaptability for switch selection. Although it is certainly contemplated that most any type of position sensing switch 59 could be utilized to serve the function of activating the stimulus generating member 61, in the embodiment shown in FIG. 4, the position sensing switch 59 is depicted as an electronic tilt switch. Such tilt switch may be of any gravity-induced design, including without limitation, a sliding cylinder or rolling ball type, or a mercury or other electrically conductive liquid type, all of which are low in cost and readily available in the market; other configurations are also possible. By utilizing the tilt switch 59, movement of the dog in any direction beyond that permitted by its handler will cause a change in the angle of the leash 3, thereby tilting the switch 59 enough (e.g., approximately above or below horizontal; see, FIG. 1) to close the switch electrical contacts and trigger the stimulus generator 61. Once activated, the stimulus generator 61 within the training device 1 generates and transmits the desired stimulus to the dog (and possibly the handler), thus alerting the dog to correct its course well prior to creating any significant tension on the leash 3.

As noted previously, it is contemplated that the stimulus generated by the training device 1 may be of any form to alert the dog, but is preferably of a non-invasive nature. For illustrative purposes, the stimulus generators 11 and 61 shown in FIGS. 2-4 are depicted as vibration motors which, upon activation, will cause the training device 1 to transmit non-invasive vibration through the leash 3 to the dog. Such a vibration motor may be similar to those commonly used in cell phones as an alternative to ring tones. Once the dog senses the vibration, it learns to correct its position relative to its handler, thereby repositioning the orientation of training device 1 to its predetermined disengaged “home” position and causing the stimulus generator to cease vibrating. As noted earlier, such stimulus may also alert the dog handler that the dog has begun to stray, thereby indirectly teaching the dog by teaching the dog handler when to stop.

While the present disclosure shows the use of a single stimulus generator 11 or 61 (e.g., vibration motor) to alert the dog, it is contemplated that the training device 1 could be configured to provide multiple stimuli, such as tone and vibration combined, or the option to provide either. This could be accomplished either by using multiple stimulus generators with a selection switch (not shown), or by using a single stimulus generator capable of generating multiple stimuli. It is also contemplated that the position sensing switch 59, as shown in FIG. 4, could be configured to remotely activate the stimulus generator 61, such as by way of radio signal, without departing from the invention herein.

While other stimulus circuit designs may certainly be conceivable to accomplish the same function, the above-described circuits are compact, simple and cost-effective. The simplicity of the training device 1 lends it to very low cost manufacturing and much higher reliability and uniformity of performance compared to other conventional leash training devices that rely principally on the application of leash tension. There are no mechanical sound generating mechanisms that are subject to wear and costly replacement, and no unreliable triggering caused by mechanical switch failure due to weather conditions, aging, etc.

With the use of such a canine training device 1 as described herein, the deficiencies of conventional leash training devices may be overcome, and the goal of loose leash training may be better achieved by teaching the pet to walk beside its handler without any jerking or pulling on the leash. Moreover, such a loose leash training device 1 may also have application in the non-invasive pre-training of a dog for use with a yard containment system (“invisible fence”) and/or for the use of hunting collars (“remote training”), both of which commonly employ the use of the controversial e-collar.

It will, of course, be understood that various changes may be made in the form, details, arrangement and proportions of the parts without departing from the scope of the invention which comprises the matter shown and described herein and set forth in the appended claims.

1. An animal training apparatus, comprising:
(a) an orientation-activated position sensor having an established orientation of conductivity, said sensor being connected to a source of electrical power;
(b) an attachment member for securing said position sensor to the animal; and
(c) a stimulus generator electrically coupled to said position sensor, said stimulus generator being activated to produce and transmit an alerting stimulus to the animal upon movement of said position sensor to said orientation of conductivity.

2. The animal training apparatus defined in claim 1, wherein said position sensor is comprised of an electrically conductive gravity-induced switch.

3. The animal training apparatus defined in claim 2, wherein said switch is comprised of a sliding cylinder, rolling ball, mercury, or other electrically conductive liquid type tilt switch member.

4. The animal training apparatus defined in claim 2, wherein said tilt switch is comprised of an electrically conductive housing within which said stimulus generator is movably carried.

5. The animal training apparatus defined in claim 4, wherein said stimulus generator is activated upon movement of said stimulus generator within said housing into engagement with said power source.

6. The animal training apparatus defined in claim 1, wherein said position sensor includes a housing having an interior chamber within which said stimulus generator is slidably carried.

7. The animal training apparatus defined in claim 6, wherein said housing includes a threaded end cap having an open cavity which communicates with said chamber, said cavity carrying said source of electrical power.

8. The animal training apparatus defined in claim 7, including an insulating member disposed between said end cap and said stimulus generator for preventing contact between said stimulus generator and said source of electrical power until said end cap is fully threaded upon said housing.

9. The animal training apparatus defined in claim 8, wherein said housing is formed of an electrically conductive material which completes the electrical coupling of said source of electrical power with said slidable stimulus generator and said position sensor.

10. The animal training apparatus defined in claim 1, wherein said stimulus generator transmits a non-invasive type stimulus to the animal based on vibration, tone, sight, scent, or a combination thereof.

11. The animal training apparatus defined in claim 1, wherein said position sensor is activated remotely.

12. The animal training apparatus defined in claim 1, wherein said attachment member is constructed for attachment of said position sensor to an animal leash, collar or other animal handling device.

13. The animal training apparatus defined in claim 1, wherein said position sensor is constructed at least in part by said stimulus generator.

14. An animal training apparatus, comprising:
(a) a position sensor including a tilt switch with an established orientation of conductivity;
(b) a source of electrical power releasably connected to said position sensor;
(c) an attachment member for securing said position sensor to the animal;
(d) a stimulus generator electrically coupled to said position sensor, said stimulus generator being activated to produce and transmit an alerting stimulus to the animal upon movement of said tilt switch to said orientation of conductivity; and
(e) said tilt switch being comprised at least in part of said stimulus generator.

15. The animal training apparatus defined in claim 14, wherein said tilt switch includes a housing with an interior chamber, said stimulus generator being slidably carried within said chamber of said housing and shiftable therein to engage said source of electrical power upon movement of said tilt switch to said orientation of conductivity.

16. The animal training apparatus defined in claim 15, wherein said housing includes an end cap threadably received on an open end of said housing, said end cap carrying said source of electrical power in communicating relation with said chamber of said housing.

17. The animal training apparatus defined in claim 16, wherein said housing is formed of an electrically conductive material so as to complete the electrical coupling of said source of electrical power with said slidable stimulus generator and said position sensor.

18. The animal training apparatus defined in claim 17, including an insulating member disposed between said end cap and said stimulus generator for preventing contact between said stimulus generator and said source of electrical power until said end cap is fully threaded upon said housing.

19. The animal training apparatus defined in claim 14, wherein said stimulus generator is constructed to transmit a non-invasive type stimulus to the animal based on vibration, tone or a combination thereof, and said tilt switch is comprised of a rolling ball, mercury, or other electrically conductive liquid type switch member.

20. An animal training apparatus, comprising:
(a) a housing with an interior chamber, said housing being formed substantially throughout of an electrically conductive material;
(b) a stimulus generator slidably carried within said chamber of said housing in electrically conductive relation thereto;
(c) a source of electrical power being carried within said housing in electrically conductive relation thereto, said source of electrical power being positioned in alignment with said stimulus generator within said chamber; and
(d) means for attaching said housing to the animal, whereupon undesirable movement of said animal will cause said stimulus generator to shift within said chamber of said housing into engagement with said source of electrical power, thereby closing the electrical circuit between said source of electrical power and said stimulus generator and causing said stimulus generator to produce and transmit an alerting stimulus to the animal.
